(19) United States
(12) Patent Application Publication
(10) Pub. No.: US 2017/0268754 A1
(43) Pub. Date: Sep. 21, 2017

(54) LIGHT-EMITTING DIODE LIGHT BULB

(71) Applicant: Yu-Lin LEE, New Taipei City (TW)

(72) Inventors: Yu-Lin LEE, New Taipei City (TW); Kuo-Chung HUANG, Taoyuan City (TW)

(21) Appl. No.: 15/072,366

(22) Filed: Mar. 17, 2016

(51) Int. Cl. F21V 19/00; F21V 23/00; F21K 99/00

(52) U.S. Cl. CPC F21V 19/0055; F21K 9/1355; F21V 23/006

(57) ABSTRACT

A light-emitting diode (LED) light bulb includes an outer housing assembly, an inner housing assembly, an LED circuit board and a lamp cap. The outer housing assembly has a non-metallic outer shell and an inner shell affixed to an inner wall of the outer shell. The inner housing assembly is mounted inside the outer housing assembly through a lower opening of the outer housing assembly and is non-metallic and elongated with one end thereof securely connected with the base. The LED circuit board is mounted on a top of the LED mounting disc. The lamp cap is non-metallic and covers the upper opening of the outer housing assembly. Because the outer housing assembly and the lamp cap enclose the LED circuit board therein, users do not easily get an electric shock when holding the outer housing assembly or the lamp cap upon mounting or dismounting the LED light bulb to or from an LED lamp holder.

### BACKGROUND OF THE INVENTION

1. Field of the Invention

The present invention relates to a light-emitting diode (LED) light bulb and, more particularly, to an LED light bulb which minimizes the risk of electric shock upon installation of the LED light bulb.

2. Description of the Related Art

With reference to FIG. 3, a conventional light-emitting diode (LED) light bulb includes a base 91, an inner housing assembly 92, an outer housing assembly 93, an LED circuit board 94 and a lamp cap 95. The base 91 is metallic, is externally threaded, and is mounted into a lamp holder through threaded connection to receive an operating power. The inner housing assembly 92 is elongated with one end thereof securely connected with a top end of the base 91 and has a tube 920, a positive terminal 921, a negative terminal 922 and an LED driver 923. The tube 920 is made of plastic, houses the positive terminal 921, the negative terminal 922 and the LED driver 923 therein, and has two fixing holes 9201 formed in a top edge portion of the tube 920. The LED driver 923 is electrically connected to the positive terminal 921, the negative terminal 922 and the base 91.

The outer housing assembly 93 is metallic, bowl-like and hollow and has a lower opening 931, an upper opening 932 and an LED mounting disc 933. The inner housing assembly 92 is mounted into the outer housing assembly 93 through the lower opening 931. The LED mounting disc 933 is mounted on a portion of an inner wall of the outer housing assembly 93 adjacent to the upper opening 932, and has two first through holes 9330 and a first terminal hole 9331 formed through the LED mounting disc 933. The LED circuit board 94 is mounted on a top of the LED mounting disc 933 and has two second through holes 940, a second terminal hole 941 and multiple LEDs 942. The two second through holes 940 and the second terminal hole 941 are formed through the LED circuit board 94. The multiple LEDs 942 are mounted on the LED circuit board 94. The positive terminal and the negative terminal sequentially pass through the first terminal hole 9331 of the LED mounting disc 933 and the second terminal hole 941 and are soldered on the LED circuit board 94 to connect to anode and cathode of the LED circuit board 94. Two self-tapping screws 943 sequentially pass through the respective second through holes 940 of the LED circuit board 94 and the respective first through holes 9330 of the mounting disc 933 to engage the respective fixing holes 9201 of the tube 920 and fasten the outer housing assembly 93 and the inner housing assembly 92 together. The lamp cap 95 is dome-like and translucent and is stuck on a top edge of the outer housing assembly 93 to cover the upper opening of the outer housing assembly 93 and the LED circuit board 94.

Upon installation of the conventional LED light bulb, users normally hold the conventional LED light bulb with fingers to grab the outer housing assembly 93 of the conventional LED light bulb. Because the outer housing assembly 93 is metallic and electrically conductive, users are susceptible to an electric shock hazard in the event of leakage current passing through the outer housing assembly 93.

### SUMMARY OF THE INVENTION

An objective of the present invention is to provide a light-emitting diode (LED) light bulb capable of preventing electric shock upon mounting or dismounting the LED light bulb to a lamp holder.

To achieve the foregoing objective, the LED light bulb includes a base, an outer housing assembly, an inner housing assembly, an LED circuit board and a lamp cap.

The base is adapted to be mounted into a lamp holder. The outer housing assembly is hollow and has a lower opening, an upper opening, an outer shell, an inner shell and an LED mounting disc. The outer shell is non-metallic.

The inner shell is metallic and is affixed to an inner wall of the outer shell. The LED mounting disc is metallic, is mounted on a portion of an inner wall of the inner shell adjacent to the upper opening, and is located below the upper opening.

The inner housing assembly is mounted inside the outer housing through the lower opening of the outer housing assembly, is elongated with one end thereof securely connected with a top end of the base, and has a tube and an LED driver.

The tube is non-metallic.

The LED driver is mounted inside the tube.

The LED circuit board is mounted on a top of the LED mounting disc, is electrically connected between the LED driver of the inner housing assembly and the base, and has multiple LEDs mounted on a top of the LED circuit board.

The lamp cap is non-metallic and is stuck on a top edge of the outer housing assembly to cover the upper opening of the outer housing assembly. The outer housing assembly and the lamp cap jointly receive the LED circuit board and the LED mounting disc of the outer housing assembly therein.

Given the foregoing LED light bulb, because all possible external portions of the LED light bulb held or touched by users are non-metallic and thus not electrically conducting, users are free of electric shock when holding the LED light bulb with fingers for mounting or dismounting the LED light bulb to or from a lamp holder.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an LED light bulb in accordance with the present invention;

FIG. 2 is an exploded perspective view of the LED light bulb in FIG. 1; and

FIG. 3 is an exploded perspective view of a conventional LED light bulb.

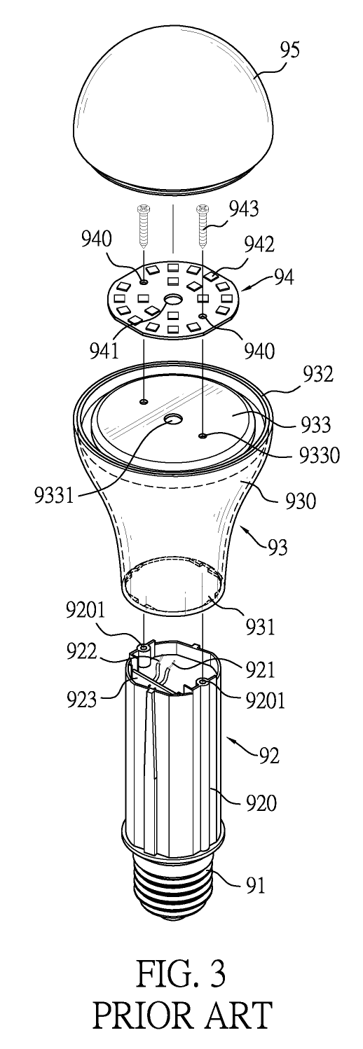

### DETAILED DESCRIPTION OF THE INVENTION

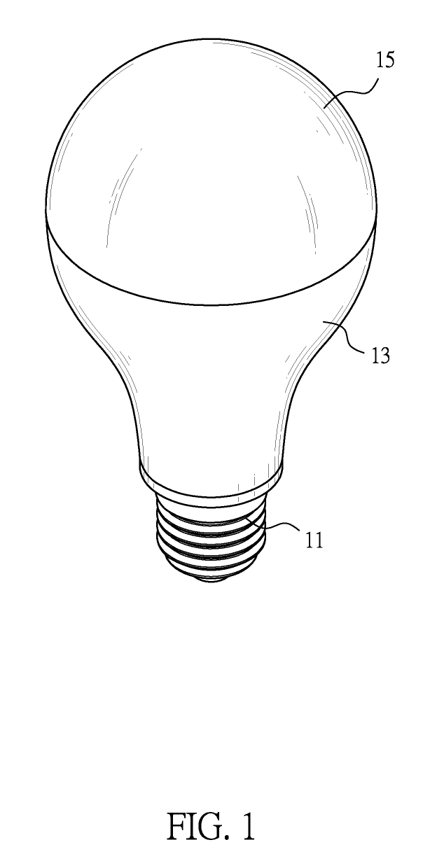

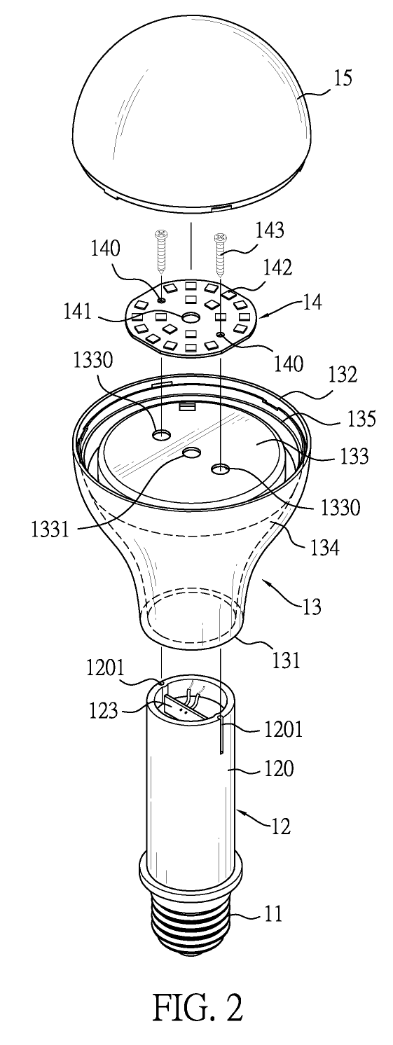

With reference to FIGS. 1 and 2, a light-emitting diode (LED) light bulb in accordance with the present invention includes a base 11, an inner housing assembly 12, an outer housing assembly 13, an LED circuit board 14 and a lamp cap 15.

The base 11 is metallic, is externally threaded, and is mounted into a lamp holder through threaded connection to receive an operating power. The inner housing assembly 12 is elongated with one end thereof securely connected with a top end of the base 11 and has a tube 120 and an LED driver 123. The tube 120 is non-metallic and has two fixing holes 1201 formed in the top end of the tube 120. The LED driver 123 is mounted inside the tube 120 and is electrically connected between the LED circuit board 14 and the base 11. In the present embodiment, the tube 120 is made of plastic.

The outer housing assembly 13 is bowl-like and hollow and has a lower opening 131, an upper opening 132, an LED mounting disc 133, an outer shell 134 and an inner shell 135.

The inner housing assembly 12 is mounted into the outer housing assembly 13 through the lower opening 131. The LED mounting disc 133 is metallic, is mounted on a portion of an inner wall of the inner shell 135 adjacent to the upper opening 132, is located below the upper opening 132, and has two first through holes 1330 and a first terminal hole 1331 formed through the LED mounting disc 133. The outer shell 134 is non-metallic. In the present embodiment, the outer shell 134 is made of plastic. The LED mounting disc 133 conducts heat generated by the LED circuit board 14 to the inner shell 135. The inner shell 135 is metallic, is affixed to an inner wall of the outer shell 134, and serves to dissipate heat generated by the LED circuit board 14 away from the LED circuit board 14. In the present embodiment, the inner shell 135 is made of aluminum. The LED circuit board 14 is mounted on a top of the LED mounting disc 133 and has two second through holes 140, a second terminal hole 141 and multiple LEDs 142. The two second through holes 140 and the second terminal hole 141 are formed through the LED circuit board 14. The multiple LEDs 142 are mounted on a top of the LED circuit board 14. Two self-tapping screws 143 sequentially pass through the respective second through holes 140 of the LED circuit board 14 and the respective first through holes 1330 of the mounting disc 133 to engage the respective fixing holes 1201 of the tube 120 and fasten the outer housing assembly 13 on the inner housing assembly 12. The lamp cap 15 is non-metallic, dome-like and translucent and is stuck on a top edge of the outer housing assembly 13. The lamp cap 15 covers the upper opening 132 of the outer housing assembly 13, and the lamp cap 15 and the outer housing assembly 13 jointly receive the LED circuit board 14 and the LED mounting disc 133 therein. In the present embodiment, the lamp cap 15 is made of plastic.

Upon installation of the LED light bulb, users can hold the LED light bulb with fingers to grab the outer shell 134 of the outer housing assembly 13. Since the outer shell 134 and the lamp cap 15 enclosing all electrically conducting elements are non-metallic, there is no hazard of electric shock when users hold the outer shell 134 and/or the lamp cap 15 to mount or dismount the LED light bulb to or from an LED lamp holder.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A light-emitting diode (LED) light bulb, comprising:
a base adapted to be mounted into a lamp holder;
an outer housing assembly being hollow and having:
a lower opening;
an upper opening;
an outer shell being non-metallic;
an inner shell being metallic and affixed to an inner wall of the outer shell; and
an LED mounting disc being metallic, mounted on a portion of an inner wall of the inner shell adjacent to the upper opening, and located below the upper opening;
an inner housing assembly mounted inside the outer housing assembly through the lower opening of the outer housing assembly, being elongated with one end thereof securely connected with a top end of the base, and having:
a tube being non-metallic; and
an LED driver mounted inside the tube;
an LED circuit board mounted on a top of the LED mounting disc, electrically connected between the LED driver of the inner housing assembly and the base, and having multiple LEDs mounted on a top of the LED circuit board; and
a lamp cap being non-metallic and stuck on a top edge of the outer housing assembly to cover the upper opening of the outer housing assembly, wherein the outer housing assembly and the lamp cap jointly receive the LED circuit board and the LED mounting disc of the outer housing assembly therein.

2. The LED light bulb as claimed in claim 1, wherein the outer shell is made of plastic.

3. The LED light bulb as claimed in claim 1, wherein the lamp cap is made of plastic.

4. The LED light bulb as claimed in claim 2, wherein the lamp cap is made of plastic.

5. The LED light bulb as claimed in claim 1, wherein
the tube of the inner housing assembly has two fixing holes formed in a top edge portion of the tube;
the LED mounting disc has two first through holes and a first terminal hole formed through the LED mounting disc;
the LED circuit board has two second through holes and a second terminal hole formed through the LED circuit board; and
two self-tapping screws sequentially pass through the respective second through holes of the LED circuit board and the respective first through holes of the mounting disc to engage the respective fixing holes of the tube and fasten the outer housing assembly on the inner housing assembly.

6. The LED light bulb as claimed in claim 2, wherein
the tube of the inner housing assembly has two fixing holes formed in a top edge portion of the tube;
the LED mounting disc has two first through holes and a first terminal hole formed through the LED mounting disc;
the LED circuit board has two second through holes and a second terminal hole formed through the LED circuit board; and
two self-tapping screws sequentially pass through the respective second through holes of the LED circuit board and the respective first through holes of the mounting disc to engage the respective fixing holes of the tube and fasten the outer housing assembly on the inner housing assembly.

7. The LED light bulb as claimed in claim 3, wherein
the tube of the inner housing assembly has two fixing holes formed in a top edge portion of the tube;
the LED mounting disc has two first through holes and a first terminal hole formed through the LED mounting disc;
the LED circuit board has two second through holes and a second terminal hole formed through the LED circuit board; and
two self-tapping screws sequentially pass through the respective second through holes of the LED circuit board and the respective first through holes of the mounting disc to engage the respective fixing holes of the tube and fasten the outer housing assembly on the inner housing assembly.

8. The LED light bulb as claimed in claim 4, wherein
the tube of the inner housing assembly has two fixing holes formed in a top edge portion of the tube;
the LED mounting disc has two first through holes and a first terminal hole formed through the LED mounting disc;
the LED circuit board has two second through holes and a second terminal hole formed through the LED circuit board; and
two self-tapping screws sequentially pass through the respective second through holes of the LED circuit board and the respective first through holes of the mounting disc to engage the respective fixing holes of the tube and fasten the outer housing assembly on the inner housing assembly.
